(19) United States
(12) Patent Application Publication
(10) Pub. No.: US 2012/0156005 A1
(43) Pub. Date: Jun. 21, 2012

(54) BUFFER AIR FOR A LABYRINTH SEAL

(75) Inventors: ENGWARD WILLIAM NIELSEN, El Cajon, CA (US); Daniel William Burnes, San Diego, CA (US); Simon Ferguson Reynolds, San Diego, CA (US); Michael Dennison Fox, San Diego, CA (US)

(73) Assignee: Caterpillar Inc.

(21) Appl. No.: 12/970,451

(22) Filed: Dec. 16, 2010

(51) Int. Cl. F02C 7/28; F04B 49/22

(52) U.S. Cl. 415/1; 417/286; 417/53

(57) ABSTRACT

A method of providing buffer air to a labyrinth seal includes operating a multi-stage compressor system having an earlier stage and a later stage such that the air pressure at the later stage is higher than the air pressure at the earlier stage. The method may further include selectively directing compressed air from one of the earlier stage or the later stage to the seal based on a parameter indicative of air pressure within the compressor system.

### TECHNICAL FIELD

The present disclosure relates generally to a system and a method to provide buffer air for a labyrinth seal.

### BACKGROUND

Gas turbine engines (“GTE”) are known to include several different sections that work together to generate power. For example, a GTE is known to include a compressor, a combustor, and a turbine. The compressor receives ambient air, compresses the air, and then forwards at least a portion of the compressed air into a combustion chamber of the combustor. While in the combustion chamber, the compressed air combines with fuel, and the GTE ignites the air/fuel mixture to create a flow of high-temperature compressed gas that flows into the turbine. The flow of high-temperature compressed gas impacts turbine blades, which cause one or more turbine rotors to rotate. Rotational energy from each turbine rotor is transferred to a drive axle to power a load, for example, a generator, a compressor, or a pump. Some of the compressed air from the compressor may be diverted before the combustion process for other uses, such as, to provide buffer air for seals of the GTE to prevent leakage of oil therethrough.

It is a common practice in gas turbine engines to supply a small quantity of air from the compressor to buffer seals, such as, for example, labyrinth seals, at various locations throughout the GTE. In one arrangement, pressurized air from the engine is delivered to an annulus between knife seals of a labyrinth seal to induce a pressure difference, and thereby prevent the leakage of oil from the low pressure side to the high pressure side of the seal. The pressure of the buffer air should be sufficient to provide an adequate air-to-oil differential pressure across the seal at all operating conditions of the GTE so that oil leakage across the seal is prevented under all conditions.

One example of a buffer air system is described in U.S. Pat. No. 6,345,954 B1 to Al-Himyary et al. (“the '954 patent”). The '954 patent discloses a dry gas seal for a compressor where buffer air for the seal is provided from the discharge side of the compressor. During normal operation, the compressor discharge air has sufficient pressure to act as buffer air. During startup and modes of operation where sufficient compressor discharge pressure does not exist, a booster compressor increases the pressure of the compressor discharge air to provide the necessary pressure differential for the dry gas seal. While the buffer air system of the '954 patent may provide buffer air at sufficient pressure during all operating conditions of the compressor, the system may have some disadvantages such as, for example, added cost. The present disclosure is directed to a system and a method to provide buffer air for a seal that decreases or overcomes shortcomings in the '954 patent and/or other shortcomings in existing technology

### SUMMARY

In one aspect, a buffer air delivery system for a labyrinth seal is disclosed. The system may include a first conduit coupled to an earlier stage of a multi-stage compressor system to the seal and a second conduit coupled to a later stage of the compressor system to the seal. The later stage is a stage of the compressor system that is positioned downstream of earlier stage. The system may also include a valve configured to selectively direct compressed air from one of the first conduit or the second conduit to the seal based on a parameter indicative of air pressure of the compressor system.

In another aspect, a method of providing buffer air to a labyrinth seal is disclosed. The method includes operating a multi-stage compressor system having an earlier stage and a later stage such that the air pressure at the later stage is higher than the air pressure at the earlier stage. The method may further include selectively directing compressed air from one of the earlier stage or the later stage to the seal based on a parameter indicative of air pressure of the compressor system.

In yet another aspect, a method of operating a gas turbine engine including a labyrinth seal is disclosed. The method includes operating a multi-stage compressor system of the gas turbine engine including an earlier stage and a later stage such that the air pressure at the later stage is higher than the air pressure at the earlier stage. The method may include directing compressed air from the later stage to the seal when an RPM of the compressor system is below a threshold value. The method may further include directing compressed air from the earlier stage to the seal when the RPM of the compressor system is at or above the threshold valve.

### BRIEF DESCRIPTION OF THE DRAWINGS

FIG. 1 is an illustration of a labyrinth seal of a GTE of the present disclosure;

FIG. 2 is a schematic illustration of a buffer air delivery system for the seal of FIG. 1;

FIG. 3 is a schematic illustration of another embodiment of the disclosed buffer air delivery system; and

FIG. 4 is a flow chart illustrating an exemplary method used to provide buffer air to the seal of FIG. 1.

### DETAILED DESCRIPTION

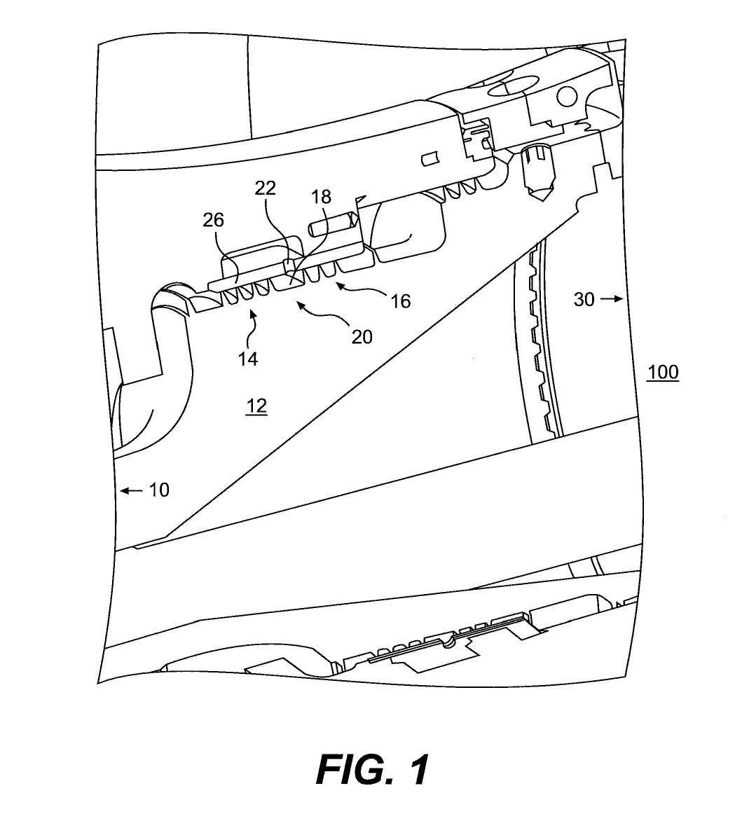

FIG. 1 illustrates a labyrinth seal (“seal”) 20 of a gas turbine engine (GTE) 100. Seal 20 may be positioned between a shaft bearing section 10 and a compressor section 30 of GTE 100, and may be serve to restrict migration of lubrication oil from the bearing section 10 to the compressor section 30. Seal 20 may include a forward portion 14 and an aft portion 16, each including a plurality of labyrinth teeth on the forward cone 12 of GTE 100. In seal 20, illustrated in FIG. 1, the forward portion 14 includes four labyrinth teeth and the aft portion 16 includes three labyrinth teeth. However, this is only exemplary and, in general, seal 20 may include any number of labyrinth teeth distributed in any manner. As is known to person of skill in the art, labyrinth seals provide non-contact sealing action by controlling the passage of fluid through a variety of chambers by centrifugal motion and by the formation of controlled fluid vortices. For seal 20 to provide non-contact sealing, a small clearance (in the order of a few thousands of an inch, not visible in FIG. 1) exists between the tips of the labyrinth teeth and ring seat 26. Due to this clearance, lubricating oil may leak through seal 20 from the bearing section 10 to the compressor section 30. To prevent or reduce this leakage of oil, pressurized air (called buffer air) is delivered to an annulus 18 between the forward and aft portions 14, 16 of seal 20 through one or more ports 22. This high pressure buffer air in annulus 18 may then flow to the left and the right through the clearance between the labyrinth teeth in the forward and aft sections 14, 16 of seal 20. The buffer air that flows to the left enters the bearing section 10 and helps to increase sump pressure by driving the oil in bearing section 10 towards the oil sump (not shown). The buffer air that flows to the right enters the compressor section 30 and gets mixed with the air in the compressor. Since the compressor section 30 is at vacuum and the bearing section 10 is at a pressure higher than atmospheric pressure, most of the buffer air from annulus 18 flows to the right and enters compressor section 30. By creating a region of high pressure in seal 20, the buffer air serves to keep the lubricating oil from migrating from the bearing section 10 to the compressor section and mixing with the inlet air of the compressor section 30. To ensure that oil leak across seal 20 is reduced (or prevented) during all operating conditions of GTE 100, buffer air at sufficient pressure may be provided to seal 20.

In some applications of GTE 100, high pressure air is drawn from the compressor section 30 and fed to seal 20 as buffer air. The pressure of the air in the compressor section 30 is highly dependent on the engine RPM. At low RPMs, such as during start-ups or shut-downs, the air pressure is low, and the air pressure builds up in a steep curve as the RPM increases. Compressor section 30 may be a multi-stage compressor and the pressure of the air in the later stages may be higher than the pressure in the earlier stages. In this context, earlier stage and later stage refers to relative positions of two stages in a multi-stage compressor, such that an earlier stage is positioned before a later stage. For instance, in a 10 stage compressor, stage 6 may be an earlier stage and stage 10 may be a later stage. In some embodiments, the earlier stage and the later stage may be positioned closer together. For instance, in the example above, stage 8 may serve as an earlier stage and stage 9 may serve as a later stage. Due to the relative positions of the earlier stage and the later stage, as air flows through compressor system 30, the air first gets compressed in the earlier stage and then further compressed in the later stage. Therefore, the air pressure in the later stage will be higher than that in the earlier stage.

While the air pressure in the earlier stages of a compressor may not be high enough to adequately buffer the seal at low RPMs, the air pressure in the later stages of the compressor may be high enough to buffer seal 20 even at low RPMs. However, at high RPMs, the air pressure in the later stages may be higher than that necessary for buffering. Using buffer air at a higher pressure than is necessary for buffering involves waste since the additional work done on the air to increase the pressure beyond what is needed for buffering is wasted. Further, higher pressure air is hotter. And as described earlier, most of the hot buffer air gets mixed with the compressor inlet air where hot air decreases performance. Therefore, it is desirable to keep the pressure of buffer air at a level that is adequate for buffering purposes without significantly exceeding this pressure.

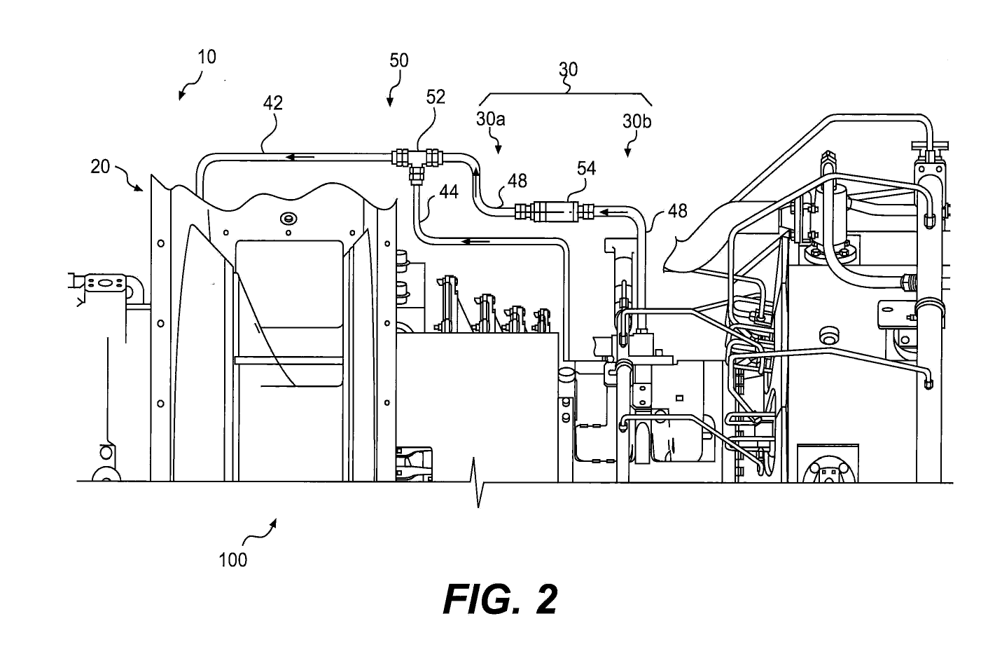

FIG. 2 shows a schematic illustration of a buffer air delivery system 50 for seal 20 of FIG. 1. The buffer air delivery system 50 includes conduits that are adapted to direct high pressure air from compressor section 30 to seal 20. These conduits include a first conduit 48 that directs compressed air from a later stage 30b of compressor system 30 to seal 20, and a second conduit 44 that directs compressed air from an earlier stage 30a of compressor system 30 to seal 20. As mentioned earlier, earlier stage is any stage of compressor system 30 that comes before, or is upstream of, a later stage. Conduits 44 and 48 may be fluidly coupled to a conduit 42 that directs the compressed air to annulus 18 of seal 20 to serve as buffer air. In some embodiments, an orifice 52 may couple conduits 44 and 48 to conduit 42. Orifice 52 may be configured to decrease the pressure and the mass flow rate of air that passes therethrough. In some embodiments, orifice 52 may only reduce the mass flow rate of air entering conduit 42 from conduit 48. In some embodiments, a valve 54 may also be positioned in conduit 48 to selectively activate the flow of compressed air through conduit 48. In some embodiments, orifice 52 and/or valve 54 may be eliminated, while in other embodiments additional devices may be positioned in one or more conduits to control flow. These devices may include other valves, flow measurement devices, safety devices, flow restriction devices, or other flow control systems.

During operation of GTE 100, compressed air from earlier stage 30a and later stage 30b may flow towards seal 20 through conduits 44 and 48, respectively. When GTE 100 operates at a low RPM (such as, for example, during start up and shut-down), the pressure of the air in compressor system 30 will generally be low. In this operating condition, the pressure of air from the earlier stage 30a may not be sufficient to adequately buffer seal 20. However, even during low RPM operation, the pressure of compressed air from the later stage 30b will be higher than that from the earlier stage 30a, and this pressure may be sufficient to buffer seal 20. Therefore, during low RPM operation, valve 54 may be open and compressed air from the later stage 30b flowing through conduit 48 may be directed through conduit 42 to seal 20 for buffering. Due to the lower pressure of the air flowing through conduit 44 (from earlier stage 30a), a small amount of air from conduit 48 may also enter conduit 44 at orifice 52, and enter the earlier stage 30a. This air will then mix with the air in the compressor section 30. However, due to the pressure differential in the conduits, most of the compressed air from conduit 48 will flow through conduit 42 towards seal 20. The orifice 52 serves to decrease the pressure and the mass flow rate of air flowing therethrough. The orifice 52 may be configured to decrease the mass flow rate of air to that which is sufficient to buffer seal 20.

As the RPM of GTE 100 increases the pressure of the air in compressor system 30 increases rapidly. At these high RPMs, the pressure of the air in earlier stage 30a may be sufficient to buffer seal 20, and the pressure of the air from later stage 30b may be higher than what is needed to buffer seal 20. At these high RPMs, valve 54 may close to prevent the flow of compressed air through conduit 48. In this operating condition, compressed air from the earlier stage 30a that flows through conduit 44 may be directed to seal 20 through conduit 42. In this manner, lower pressure air from the earlier stage 30a of the compressor section 30 may be used to buffer the seal 20 when the pressure of this air is sufficient for buffering. If the RPM of GTE 100 changes to below a value where the air pressure at the earlier stage 30a is too low for buffering, valve 54 may open to allow air from the later stage 30b to be directed to the seal 20 for buffering.

Valve 54 may include any type of valve known in the art. In some embodiments, valve 54 may be a check valve which may close when the pressure of the compressed air in conduit 48 exceeds a threshold value, or the pressure differential across valve 54 exceeds a threshold value. In some embodiments, valve 54 may include an electronically controlled valve which closes when a pressure threshold is exceeded, or another condition is satisfied. A condition, such as speed of the engine, temperature of the air, etc. which is indicative of the pressure of the air in different stages of compressor system 30 may be used as the condition that triggers the activation of valve 54. Although the description above describes buffering a seal of GTE 100, this is not a limitation. In general, one or more labyrinth seals used in any application may be buffered using the system disclosed herein.

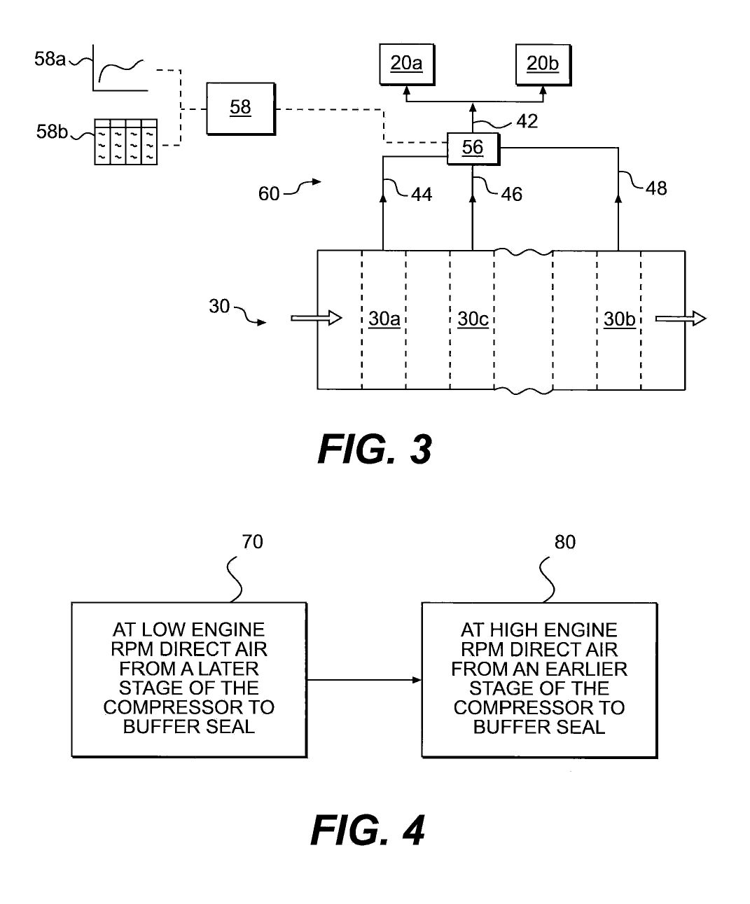

FIG. 3 illustrates a schematic illustration of another embodiment of buffer air delivery system 60 that may be used to buffer multiple seals (for example, a first seal 20a and a second seal 20b) used in any application. In the embodiment of FIG. 3, conduits 44, 46, and 48 may be fluidly coupled to an earlier stage 30a, an intermediate stage 30c, and a later stage 30b, respectively, of a multi-stage compressor system 30. As described previously, earlier stage 30a, intermediate stage 30c, and later stage 30c refer to the relative position of the stages in the multi-stage compressor system 30, such that the intermediate stage 30c is positioned between (downstream of) the earlier stage 30a and (upstream of) the later stage 30c. These conduits may be fluidly coupled to a conduit 42 at a control valve 56. Control valve 56, controlled by a control system 58, may selectively direct compressed air from one or more of the conduits 44, 46, and 48 to conduit 42 based on the pressure of the air in the respective conduits. Conduit 42 may direct the compressed air to seals 20a and 20b to buffer the seals.

Due to the relative positions of the different stages (earlier stage 30a, the intermediate stage 30c, and the final stage 30c) in compressor system 30, at any RPM, the air pressure at the later stage 30b will be higher than that in the intermediate stage 30c, and the air pressure in the intermediate stage will be higher than that in the earlier stage 30a. The control system 58 may include one or more maps 58a, 58b that indicate the air pressure in different stages of compressor system 30a based on measured operating parameters. It is also contemplated that, in some embodiments, the control system 58 may calculate the air pressure based on mathematical models or other algorithms. Based on these air pressures, control system 58 may activate control valve 56 to provide buffering air at sufficient pressure to seal 20. For instance, control system 58 may activate control valve 56 to direct flow from conduit 48 to conduit 42 during low RPM operation when the air pressure in the earlier stage 30a and the intermediate stage 30c may be too low for buffering seals 20a, 20b, and direct flow from conduit 44 to conduit 42 during high RPM operation when the air pressure in the earlier stage 30a may be sufficient for buffering the seals 20a and 20b. When the RPM of the compressor system 30 is such that the air pressure in the earlier stage 30a too low and the air pressure in the intermediate stage 30c is sufficient for buffering, the control system 58 may activate control valve 56 to direct flow from conduit 46 to seal 20.

Although in the description above a single conduit (conduit 42) is described as providing buffering air at the same pressure to both seals 20a, 20b, this is not a limitation. It is contemplated that in some embodiments, control valve 56 may direct air at different pressures to buffer different seals. For instance at a first RPM, control valve 56 may direct air from conduit 48 to seal 20a and air from conduit 46 to seal 20b, and at a second RPM, control valve 56 may direct air from conduit 46 to seal 20a and conduit 44 to seal 20b. Further, although compressed air from three stages of compressor system 30 are described as being used for buffering, this is only exemplary, and in general, air from any number of stages may be selectively directed to a seal for buffering. It is also contemplated that, in some embodiments, control system 58 may activate control valve 56 to mix different amounts of air from the different stages to provide as buffering air to the different seals.

### INDUSTRIAL APPLICABILITY

The disclosed system and method to provide buffer air for a seal may be applicable to any application where it is desired to provide buffering air of a sufficient pressure to buffer the seal while minimizing wasted work. A method of using the buffer air system will now be described using an exemplary application.

With reference to FIG. 2, GTE 100 may include a 13 stage compressor system 30 having one or more labyrinth seals 20. During operation of GTE 100, compressed air may be directed from the compressor system 30 to buffer the seal 20. FIG. 4 is a flow chart that illustrates an exemplary method used to provide buffer air to seal 20. At low RPMs of GTE 100, compressed air from a later stage (such as, between stage 9 and stage 12, for example, stage ten) of the compressor system may be directed to seal 20 as buffer air (step 70). As the RPM of engine increases, the pressure of air in compressor system 30 also increases. At such an operating condition, the air pressure at stage 10 may be significantly higher than what is needed to buffer the seal, and using this air to buffer the seal 20 may increase waste and reduce efficiency. Therefore, when the engine RPM (or another parameter that is indicative of air pressure) exceeds a threshold value, compressed air from an earlier stage (such as, between stage 4 and stage 7, for example, stage 6) may be directed to seal 20 as buffer air (step 80).

Providing buffer air at sufficient pressure to prevent oil leak at the seal, while switching the source of the buffer air to minimize wasted work improves the overall efficiency of GTE 100. Since expensive components and modifications are not needed to implement the buffer air system, the disclosed buffer air system provides an efficient and cost effective approach to buffer the seals.

It will be apparent to those skilled in the art that various modifications and variations can be made to the system and method to provide buffer air for a labyrinth seal without departing from the scope of the disclosure. Other embodiments of the system and method will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A buffer air delivery system for a labyrinth seal, comprising:
a first conduit coupled to an earlier stage of a multi-stage compressor system;
a second conduit coupled to a later stage of the compressor system, wherein the later stage is a stage of the compressor system that is positioned downstream of earlier stage; and
a valve configured to selectively direct compressed air from one of the first conduit or the second conduit to the seal based on a parameter indicative of air pressure within the compressor system.

2. The system of claim 1, wherein the valve directs air from the first conduit to the seal at a first RPM of the compressor system and directs air from the second conduit to the seal at a second RPM of the compressor system, the first RPM being higher than the second RPM.

3. The system of claim 1, further including an orifice positioned in the second conduit, the orifice being configured to reduce a mass flow rate of air flowing therethrough.

4. The system of claim 1, wherein the valve is a check valve that is configured to activate based on a pressure of air flowing therethrough.

5. The system of claim 1, wherein the valve is an electronically controlled valve that is operatively coupled to a control system, the control system being configured to activate the valve based on the parameter.

6. The system of claim 1, wherein the parameter is one of an RPM of the compressor system, a pressure of the air, or a temperature of the air.

7. The system of claim 1, further including a third conduit that fluidly couples the first conduit and the second conduit to the seal.

8. The system of claim 1, wherein the valve is positioned in the second conduit.

9. The system of claim 8, wherein the seal is part of a gas turbine engine and the earlier stage is a stage between stage 4 and stage 7 of the compressor system and the later stage is a stage between stage 9 and stage 12 of the compressor system.

10. A method of providing buffer air to a labyrinth seal, comprising:
operating a multi-stage compressor system having an earlier stage and a later stage such that the air pressure at the later stage is higher than the air pressure at the earlier stage; and
selectively directing compressed air from one of the earlier stage or the later stage to the seal based on a parameter indicative of air pressure within the compressor system.

11. The method of claim 10, wherein the selectively directing includes directing compressed air from the later stage to the seal at a low RPM of the compressor system and directing compressed air from the earlier stage to the seal at a high RPM of the compressor system.

12. The method of claim 11, wherein the selectively directing includes stopping the flow of compressed air from the later stage to the seal when the RPM increases above a threshold value.

13. The method of claim 10, wherein the selectively directing includes reducing the mass flow rate of compressed air flowing to the seal from the later stage.

14. The method of claim 10, wherein selectively directing includes switching compressed air supply to the seal from the later stage to the earlier stage when the air pressure exceeds a threshold value.

15. The method of claim 14, wherein selectively directing further includes switching the compressed air supply to the seal from the earlier stage to the later stage when the air pressure decreases below a threshold value.

16. The method of claim 10, wherein selectively directing includes directing compressed air from the later stage to the seal during at least one of start-up or shut-down of the compressor system.

17. A method of operating a gas turbine engine including a labyrinth seal, comprising:
operating a multi-stage compressor system of the gas turbine engine including an earlier stage and a later stage such that the air pressure at the later stage is higher than the air pressure at the earlier stage;
directing compressed air from the later stage to the seal when an RPM of the compressor system is below a threshold value; and
directing compressed air from the earlier stage to the seal when the RPM of the compressor system is at or above the threshold valve.

18. The method of claim 17, wherein directing compressed air from the earlier stage includes closing the supply of compressed air from the later stage to the seal.

19. The method of claim 17, wherein directing compressed air from the later stage includes reducing the mass flow rate of compressed air flowing from the later stage to the seal.

20. The method of claim 17, wherein directing compressed air from the later stage includes directing compressed air from the later stage during at least one of start-up or shut-down of the gas turbine engine.
